(19) United States
(12) Patent Application Publication
(10) Pub. No.: US 2024/0249327 A1
(43) Pub. Date: Jul. 25, 2024

(54) System for Designing Jewelry and Facilitating Transactions

(71) Applicant: Muhannad Abbad, Mississauga (CA)

(72) Inventor: Muhannad Abbad, Mississauga (CA)

(21) Appl. No.: 18/100,686

(22) Filed: Jan. 24, 2023

(51) Int. Cl. G06Q 30/0601; G06Q 10/083; G06Q 30/0282; G06Q 30/08

(52) U.S. Cl. CPC G06Q 30/0621; G06Q 10/083; G06Q 30/0282; G06Q 30/0627; G06Q 30/0643; G06Q 30/08

(57) ABSTRACT

A computer-implemented system for designing and purchasing jewelry is provided. The system includes a computer server with a processor, memory, and a network interface connecting it to a communication network. The server is in communication with a database used to store information related to a plurality of items of jewelry available for purchase. The system includes interfaces, such as a web or graphical user interface, for communication between the server and both a jewelry electronic device, such as a jewelry store's inventory management system, and a customer electronic device, such as a smartphone or computer. The jewelry electronic device interface receives information about items of jewelry available for purchase and related components, while the customer electronic device interface allows for the selection and customization of an item of jewelry for purchase.

### BACKGROUND OF THE INVENTION

The present invention relates to a system for designing jewelry and facilitating transactions. More specifically, the present invention relates to a computer implemented system for designing custom jewelry, posting bids, and listing and searching for jewelry stores within certain parameters, such as location.

Traditionally, the process of designing and purchasing jewelry has been a time-consuming task, often involving visiting multiple jewelry stores and browsing catalogs to find the perfect piece. With the advent of online systems, customers can now browse catalogues and purchase jewelry from the comfort of their own homes, but these systems often lack the personal touch and detailed information needed for customers to make informed decisions. Existing online systems may also lack efficient communication between the customer and the jeweler, which can lead to misunderstandings and dissatisfaction with the final product. Additionally, the existing systems may not have the functionality of filtering and searching for the jewelry store within certain location and radius.

The current invention overcomes these deficiencies by providing a computer-implemented system that enables customers to fully customize their jewelry, communicate with jewelers during the design process, and search and filter jewelers based on their location. The system includes a computer server that is in communication with a database used to store information about a plurality of items of jewelry available for purchase and jewelers' information. The system also includes interfaces, such as a web or graphical user interface, for communication between the server and both a jewelry electronic device, such as a jewelry store's inventory management system, and a customer electronic device, such as a smartphone or computer. The customer can use this interface to select and customize an item of jewelry, post bids on their custom jewelry project, and search and filter jewelers based on location and other parameters. Furthermore, the system provides a number of features such as a digital proof of an item, options for cancellation, return policy, insurance, warranty, certification of authenticity and jeweler preference settings.

In light of the devices disclosed in the known art, it is submitted that the present invention substantially diverges in design elements and methods from the known art and consequently it is clear that there is a need in the art for an improvement for a system that enables customers to fully customize their jewelry, communicate with jewelers during the design process, and search and filter jewelers based on their location. In this regard the instant invention substantially fulfills these needs.

### SUMMARY OF THE INVENTION

In view of the foregoing disadvantages inherent in the known types of system for designing jewelry and facilitating transactions now present in the known art, the present invention provides a new system for designing jewelry and commercing with jewelers, wherein the same can be utilized for enabling customers to fully customize their jewelry.

It is an objective of the present invention to provide a system for designing jewelry that allows customers to fully customize their jewelry and communicate with jewelers during the design process. The invention enables the customers to express their individual tastes and preferences by specifying design specifications and selecting components, and the communication between customer and jewelers helps ensure the final product meets their exact specifications.

It is an objective of the present invention to provide a system for designing jewelry that enables customers to easily search and filter jewelers based on their location. This feature allows customers to find jewelers that are within a certain distance from their location and make it easier for them to find jewelers that are more convenient for them to visit, whether in-person or virtual.

It is also an objective of the present invention to provide a system for designing jewelry that allows for posting of custom jewelry project for jewelers to bid on. This allows customers to find jewelers that are interested in their specific custom jewelry project and have them bid on it, giving them more options to choose from and possibly getting a better price.

Moreover, it is an objective of the present invention to provide a system for designing jewelry that facilitates communication between the customer and the jeweler through the system. This ensures that the customer and jeweler are on the same page, reducing the chances of misunderstandings, dissatisfaction with the final product, and delays.

It is an objective of the present invention to provide a system for designing jewelry that includes an escrow system that holds payment until the custom jewelry is completed and delivered to the customer. This provides a level of security for the customer, ensuring that they only pay for the jewelry after they receive it and are satisfied with it.

It is therefore an object of the present invention to provide a new and improved system for designing and purchasing jewelry that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the system for designing jewelry and facilitating transactions of jewelry.

FIG. 2 shows an embodiment of a customer interface on the customer electronic device.

FIG. 3 shows a flowchart of an exemplary use by a customer of the system to locate a jewelry store.

FIG. 4 shows a flowchart of the design engine for creating custom jewelry.

FIG. 5 shows a flowchart of a posting a job on the workboard.

### DETAILED DESCRIPTION OF THE INVENTION

Reference is made herein to the attached drawings. Like reference numerals are used throughout the drawings to depict like or similar elements of the system for designing and purchasing jewelry. For the purposes of presenting a brief and clear description of the present invention, the preferred embodiment will be discussed as used for viewing inventory from jewelry stores, creating custom jewelry, posting custom designs to work boards to receive bids from jeweler. The figures are intended for representative purposes only and should not be considered to be limiting in any respect.

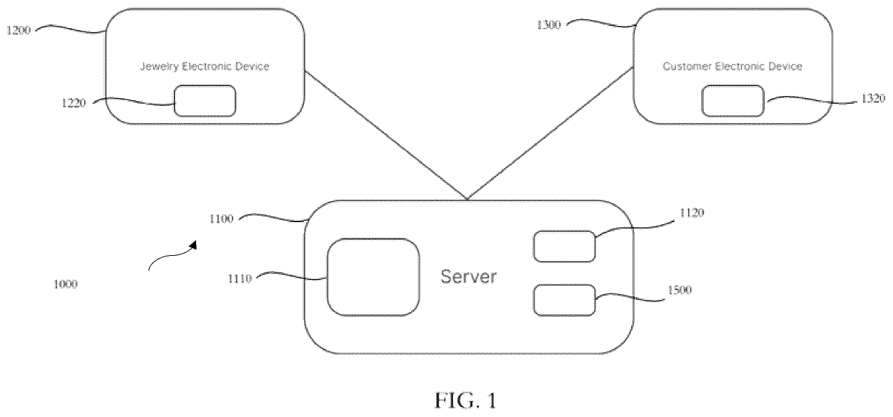

Referring now to FIG. 1, there is shown a block diagram of an embodiment of the system for designing jewelry and facilitating transactions of jewelry. The present invention provides a computer-implemented system 1000 for designing and purchasing jewelry. The system 1000 includes a computer server 1100 with a processor, memory, and a network interface 1120 connecting it to a communication network. The server 1100 is operably connected to a database 1110 used to store information. The information within the database 1110 is related to a plurality of items of jewelry available for purchase, as well as information related to customers, jewelers, communications therebetween, and the like. The system 1000 includes interfaces, such as a web or graphical user interface for communication between the server 1100 and both a jewelry electronic device 1200, such as a jewelry store's inventory management system, and a customer electronic device 1300, such as a smartphone or computer.

The jewelry electronic device interface 1210 is accessible from the jewelry electronic device and is adapted to receive information about a plurality of items of jewelry available for purchase. Additionally, the items of jewelry available to purchase may include related components, including, but not limited to jump findings, clasps, rings, headpins, crimps, clasps, endcaps, bails, bead caps, and ear wires. The customer electronic device interface 1310 is adapted to receive information from customers and allow them to select and customize an item of jewelry for purchase.

In the shown embodiment, the server 1100 including a processor, memory, and a network interface connecting the computer server to a communication network. The communication network includes wired and wireless communications over a wide variety standard, such as Wi-Fi, Bluetooth, and the like.

In one embodiment, the server 1100 is configured to communicate with the jewelry electronic device 1200 having a first interface 1210 and with a customer electronic device 1300 having a second interface 1310. The interfaces include, but are not limited to graphical user interfaces, application programming interface, file transfer protocol, and electronic Data interchange. Graphical user interfaces utilize visual elements such as icons, buttons, and menus. These interfaces are used in web and mobile applications and can be used to receive and send information related to the design and purchase of jewelry.

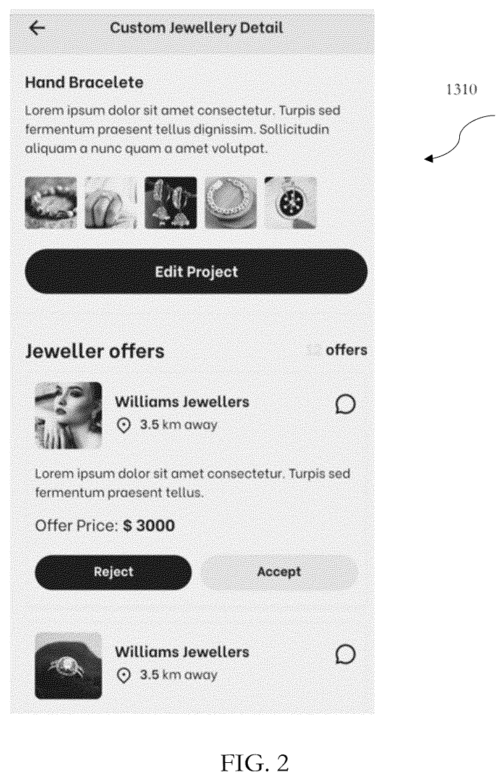

Referring now to FIG. 2, there is shown an embodiment of a customer interface on the customer electronic device. In the shown embodiment, the customer electronic device interface 1310 is a graphical user interface, (GUI) which provides the user with icons, buttons, and menus for accessing different aspects of the present invention.

In one embodiment, the customer electronic device comprises a GPS chip, or other location tracking technologies, such as Wi-Fi, and cellular networks. The customer electronic device is adapted to detect a location thereof and communicate the location to the server and the jeweler. In one embodiment, the jeweler signs up to be listed on the database or is otherwise added. In the shown embodiment, the GUI shows the relative distance of a selected jeweler. The location-based system of the customer electronic device allows customers to easily find and select jewelry stores that are within a certain distance from their location. This feature is accessed through the customer electronic device, which can be a smartphone or computer, and is accessed by a customer opening the application or website associated with the system.

In the shown embodiment, a custom project for a bracelet is shown on the customer electronic device interface. The customer electronic device interface provides for the editing of the project (such as changing gem type, gem size, gem cut, metal type, metal shape), upload of files and images, and communication between the customer and the jeweler.

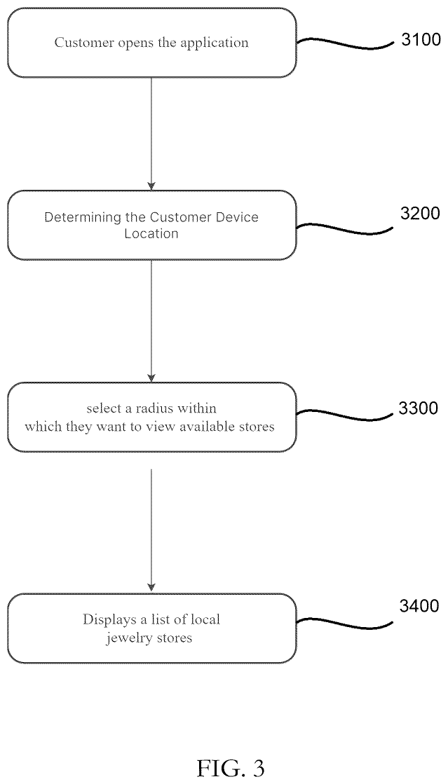

Referring now to FIG. 3, there is shown a flowchart of an exemplary use by a customer of the system to locate a jewelry store. In one exemplary use, when the customer opens the application 3100 on the customer electronic device, the system prompts the customer to turn on location services on their device. This is done by accessing the GPS chip built into the customer electronic device. Once the location services are turned on, the system is able to determine the customer's current location 3200. Upon determining the location, the system displays a list of local jewelry stores on a page of the application or website. The list is sorted by distance from the customer's location, with the closest stores appearing at the top of the list. The customer can then select a radius 3300 within which they want to view available stores and view their inventory. The system filters the list of jewelry stores based on the location of the customer electronic device and displays the relevant stores 3400.

In addition to determining the customer's location based on their device's GPS chip, the system can also determine the customer's location based on other information provided by the customer, such as a reference location. This can be useful for customers who are not currently near their desired location, but still want to search for stores in that area.

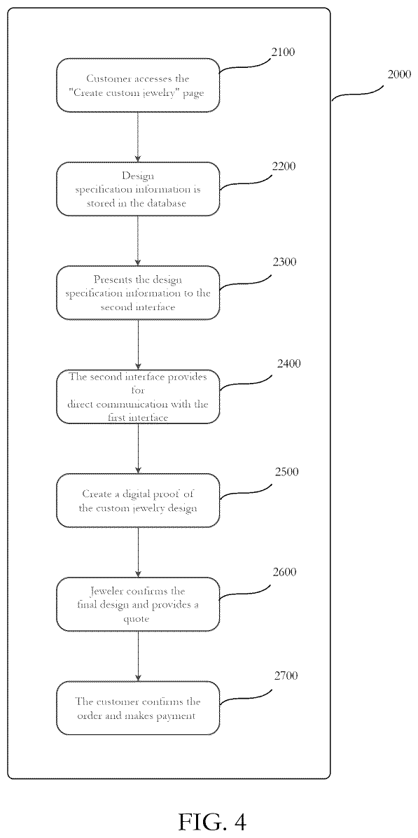

Referring now to FIG. 4, there is shown a flowchart of the design engine for creating custom jewelry. The design engine 2000 is adapted to allow a customer to design their own jewelry based on available components. The customer interface presents a customer with a list of options for designing jewelry.

To begin, the customer accesses the “Create custom jewelry” page (or similarly named page) on the application and inputs design specification information relating to the desired piece of jewelry 2100. The design specification information can include parameters such as carat weight, clarity, color, cut, price, and shape of the gemstones. The system stores the design specification information in the database 2200. The design engine uses the stored design specification information to facilitate the creation of custom jewelry with a plurality of gem attributes. The design engine 2000 uses a search engine to search the database for an item of jewelry that matches the search parameters input by the customer. The system presents the design specification information related to the selected item of jewelry to the jeweler electronic device via the second interface 2300. The second interface provides for direct communication with the first interface, allowing for text and file communication between the customer and jeweler electronic device 2400. The jeweler uses the design specification information to create a digital proof of the custom jewelry design, which can be viewed by the customer through the system's interface 2500. The customer reviews the digital proof and can request changes if needed. In one embodiment, the digital proof may be marked up directly through the interface. Once the customer is satisfied with the final design, the jeweler confirms the final design and provides a quote for the piece 2600. The customer confirms the order and makes payment through the system's escrow system 2700. The jeweler starts production and updates the customer on the progress through the system's chat feature. Once the jewelry is complete, the jeweler ships it to the customer and provides tracking information through the system.

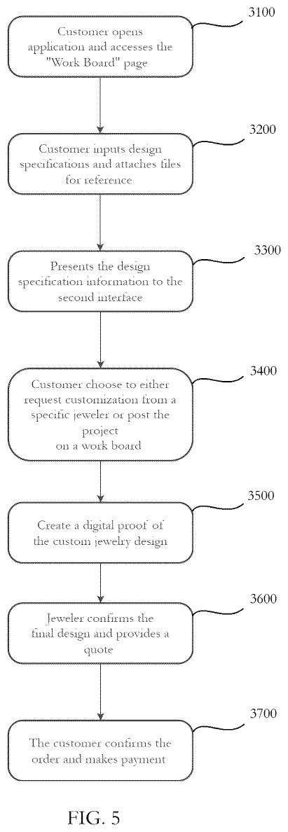

Referring now to FIG. 5, there is shown a flowchart of a posting a job on the workboard. In one exemplary use, the customer opens application and accesses the “Work Board” page on their smartphone or computer and navigates to the appropriate page 3100. This page allows the customer to input information about the jewelry they want to have custom-made. Customer inputs design specifications and attaches files for reference 3200. The customer uses the interface provided by the system to input information about the design they want, such as the type of metal, the type of gemstones, and the desired size and shape of the piece. The information from the customer is shared with the jewelers via the second interface 3300. They can also attach files, such as images or sketches, for reference. The customer can either choose to send a request for customization to a specific jeweler or post the project on a work board for jewelers to bid on 3400. The jeweler receives the request and uses the information provided by the customer to create a digital render of the design 3500. The digital proof can be viewed by the customer through the system's interface.

The customer then reviews digital proof and may request changes if needed. Once the customer is satisfied with the final design, the jeweler confirms the final design and provides a quote for the piece 3600. The customer confirms the order and makes payment through the system's payment system 3700. The jeweler starts production and provides updates to the customer through the system's chat feature. Once the jewelry is complete, the jeweler ships it to the customer and provides tracking information through the system or provides for local pickup.

In one embodiment, the present invention provides a computer-implemented method for designing jewelry and facilitating transactions. The method comprises receiving jeweler information relating to a plurality of items of jewelry available for purchase and components related to the plurality of items from the first interface of the jewelry electronic device, wherein the received information is stored in the database. The system receives customer information and a selection of an item of jewelry for purchase from the second interface of the customer electronic device, and displays the stored information on the second interface to the customer. The customer is prompted to customize the selected item of jewelry by specifying design specifications or selecting components. Additionally, the systems facilitates communication between the customer and the jeweler, as well as facilitating payment and delivery of the customized item of jewelry.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for designing jewelry and facilitating transactions, comprising:
a computer server including a processor, memory, and a network interface connecting the computer server to a communication network;
wherein the server is in communication with a database used to store information;
wherein the server is configured to communicate with a jewelry electronic device having a first interface and with a customer electronic device having a second interface;
wherein the first interface is adapted to receive jeweler information relating to a plurality of items of jewelry available for purchase and components related to the plurality of items;
wherein the second interface is adapted to receive customer information related to a plurality of items of jewelry and for receiving from customers a selection of an item of jewelry for purchase;
wherein the database is configured for storing the information relating to the plurality of items.

2. The system of claim 1, wherein the first and second interfaces comprises any one of a graphical user interface and a receiver for receiving transmissions.

3. The system of claim 2, wherein the first and second interfaces is a graphical user interface accessible through the web.

4. The system of claim 3, wherein the at least one customer electronic device is adapted to detect a location thereof.

5. The system of claim 4, wherein the system is configured to filter jewelry stores based on the location of either the at least one customer electronic device or a reference location.

6. system of claim 5, wherein the system is configured to display a list of local jewelers and their distances from the customer on the second interface.

7. The system of claim 6, wherein the system is configured to receive inventory and jewelry store information from the jewelry electronic device via the first interface.

8. The system of claim 7, wherein the system is configured to receive a radius selection within which to view available jewelers and view their inventory from the second interface.

9. The system of claim 5, further comprising a design engine to facilitate the creation of custom jewelry with a plurality of gem attributes.

10. The system of claim 9, wherein the server is configured to receive design specification information relating to the design of the piece of jewelry from the second interface and store the design specification information in the database.

11. The system of claim 10, wherein the design specification information corresponds to one of carat weight, clarity, color, cut, price, and shape.

12. The system of claim 10, wherein the design engine is adapted to create a three-dimensional computer model of the jewelry from the design specification information.

13. The system of claim 11, wherein the search engine searches the database for an item of jewelry that matches the search parameters.

14. The system of claim 13, wherein the second interface provides for direct communication with the first interface, wherein text and file communication is provided.

15. The system of claim 14, wherein the system comprises logic for presenting to the jeweler electronic device, via the second interface, the design specification information related to an item of jewelry selected by the customer.

16. The system of claim 15, wherein a request for bids is sent to a jeweler via the first interface from the customer, where in the request includes a post on a work board that allows for jewelers to bid the request.

17. The system of claim 6, further comprising a payment system that holds payment until the custom jewelry is completed and delivered to the customer.

18. The system of claim 17, wherein the first and second interfaces are configured to display reviews and ratings.

19. A computer-implemented method for designing jewelry and facilitating transactions, the method comprising:
receiving jeweler information relating to a plurality of items of jewelry available for purchase and components related to the plurality of items from the first interface of the jewelry electronic device;
storing the received information in the database;
receiving customer information and a selection of an item of jewelry for purchase from the second interface of the customer electronic device;
displaying the stored information on the second interface to the customer;
allowing the customer to customize the selected item of jewelry by specifying design specifications or selecting components;
facilitating communication between the customer and the jeweler through the system;
facilitating payment and delivery of the customized item of jewelry.
